(19) United States
(12) Patent Application Publication
(10) Pub. No.: US 2004/0212479 A1
(43) Pub. Date: Oct. 28, 2004

(54) Method and system for remote monitoring and control utilizing radio frequency devices

(75) Inventors: Ronald W. Gilbert, Gilroy, CA (US); Kerry D. Steele, Kennewick, WA (US); Gordon A. Anderson, Benton City, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Battelle Memorial Institute, Richland, WA (US)

(21) Appl. No.: 10/425,253

(22) Filed: Apr. 28, 2003

(51) Int. Cl. H04Q 5/22

(52) U.S. Cl. 340/10.34; 340/825.72

(57) ABSTRACT

A method and device for remote monitoring of conditions and control of objects that includes an antenna configured to receive and send radio frequency signals, a receiver configured to receive the radio frequency signal and to operate from the power of the received radio frequency signals, a microcontroller coupled to the receiver and configured to respond to the radio frequency signals to report a condition and to control an associated object. The microcontroller may be powered by the radio frequency signal or may receive power from a stored energy source or an external power source.

### BACKGROUND OF THE INVENTION

1. Field of the Invention

The disclosed embodiments of the present invention pertain to remote tracking and controlling of objects, and, more particularly, to a radio frequency tag configured to receive input signals and generate output control signals, respectively, via a low-power microcontroller.

2. Description of the Related Art

Remote monitoring of objects has become readily available with the advent of low-cost radio frequency identification (RFID) systems. Such systems utilize tags that, when applied to objects, respond to radio frequency interrogation signals, as described in more detail below, to provide information about an object associated with the tag or about the environment in which the tag is located.

As shown in FIG. 1, a basic RFID system 10 includes two components: a reader or interrogator 12, and a transponder (commonly called an RFID tag) 14. The interrogator 12 and RFID tag 14 include respective antenna circuits 16, 18. In operation, the interrogator 12 transmits through its antenna circuit 16 a radio frequency interrogation signal 20 to the antenna circuit 18 of the RFID tag 14. In response to receiving the interrogation signal 20, the RFID tag 14 produces a modulated radio frequency signal 22 that is reflected back to the interrogator 12 through the tag antenna 18 by a process known as continuous wave backscatter.

The substantial advantage of RFID systems is the non-contact, non-line-of-sight capability of the technology. The interrogator 12 emits the interrogation signal 20 with a range from one inch to one hundred feet or more, depending upon its power output and the radio frequency used. Tags can be read through a variety of substances such as odor, fog, ice, paint, dirt, and other visually and environmentally challenging conditions where bar codes or other optically read technologies would be useless. RFID tags can also be read at high speeds, in most cases responding in less than one hundred milliseconds.

A typical RFID system 10 often contains a number of RFID tags 14 and the interrogator 12. RFID tags are divided into three main categories. These categories are beam powered passive tags, battery powered semi-passive tags, and active tags. Each operates in different ways.

The beam-powered RFID tag is often referred to as a passive device because it derives the energy needed for its operation from the interrogation signal beamed at it. The tag rectifies the energy field and changes the reflective characteristics of the tag itself, creating a change in reflectivity that is seen at the interrogator. A battery powered semi-passive RFID tag operates in a similar fashion, modulating its RF cross-section in order to reflect a delta to the interrogator to develop a communication link. Here, the battery is the source of the tag's operational power for optional circuitry. The passive and semi-passive devices, or non-active devices, reflect the energy from the interrogation signal. In contrast, in an active RFID tag, a transmitter is used to generate its own radio frequency energy powered by the battery.

This use of radio frequency identification systems has been expanded to include monitoring of devices to detect tampering and prevent unauthorized access or theft, thus increasing security and controlling access.

For example, U.S. Pat. No. 6,262,664 describes a tamper detection prevention system for controlling and tracking an object. This system utilizes a tether, such as a resistive or conductive keychain, that when cut or tampered with alters its properties. An associated battery powered microcontroller notes the event and initiates communication with a key controller, either by contact plates or via radio frequency, to alert security personnel, activate alarms, and otherwise secure the lock. A disadvantage of this system, as with other similar systems, is that it requires the use of a storage battery to power the microcontroller. Storage batteries increase cost, weight, and are not integratable. Moreover, these batteries have a limited useful life, requiring continual testing and replacement. In addition, the microcontroller does not directly control the door lock, which instead requires a key controller circuit that communicates with the microcontroller and then provides commands to the other devices.

### BRIEF SUMMARY OF THE INVENTION

The disclosed and claimed embodiments of the present invention are directed to a method and device for input and output control associated with a passive radio frequency device. In one embodiment, an apparatus is provided that includes an antenna configured to receive and send radio frequency signals; a receiver circuit coupled to the antenna, and preferably configured to operate from the power of the radio frequency signal; and a microcontroller having input pins and output control pins. Ideally the microcontroller operates from the power of the received signals and generates output control signals responsive to signals from the receiver circuit.

In accordance with another aspect of the present invention, the microcontroller is battery-powered and is configured to wake up in response to the interrogation signal. Preferably, the RF link remains passive.

In accordance with a further aspect of the foregoing embodiment, the device is part of a system that includes an interrogator configured to transmit the radio frequency signals with sufficient power to operate the receiver circuit, and preferably the microcontroller, the radio-frequency signals including control signals for having the microcontroller generate output control signals to associated objects.

In accordance with yet another aspect of the foregoing embodiment, the device is configured to provide backscatter radio-frequency communication responsive to the received radio signal. Such communication can include data regarding a condition, such as temperature, or the status of an associated object, i.e., is it in an on or an off condition, has it changed location, and the like.

In accordance with another embodiment of the invention, a device is provided for input and output control utilizing two-way radio frequency communication, the device having an antenna configured to receive radio frequency signals; a receiver circuit coupled to the antenna and configured to operate from the power of the radio frequency signal; and a microcontroller having input pins and output control pins and configured to operate on either the power from signals received from the receiver circuit, an energy storage device, or both, and to receive input signals from one or more associated sensors and to generate output control signals responsive to the input signals from the one or more sensors, the output signal operative to control one or more associated objects.

In accordance with another aspect of the foregoing embodiment, a system is provided that includes the foregoing device and an interrogator configured to generate the radio frequency signals and to receive signals from the device regarding the condition of the apparatus, which can include input signals from the one or more sensors, the output control signals, and the status of the one or more associated objects.

In accordance with yet another embodiment of the present invention a device is provided for input and output control utilizing two-way radio frequency communication, the device having an antenna configured to receive and send radio frequency signals; a receiver circuit coupled to the antenna and configured to operate from the power of the received radio frequency signals; and a microcontroller configured to operate from the power of the radio frequency signals at the receiver circuit and to generate output control signals responsive to the radio frequency signals. Ideally the microcontroller is configured to respond to a lack of power from the receiver circuit to shut off an associated object, such as when the power from the receiver circuit drops below a predetermined level; and further to activate the associated object when the power from the receiver circuit is at or above a predetermined level.

In accordance with the foregoing embodiment, a system is provided that includes the device and an interrogator configured to generate the radio frequency signals with sufficient power to operate the receiver circuit and the microcontroller. Ideally, the interrogator is configured to receive backscattered signals from the device that can include information regarding the status of one or more associated objects or of a condition.

In accordance with a method of the present invention, a low-power microcontroller circuit is associated with a radio frequency receiver coupled to an antenna for two-way radio-frequency communication; the receiver and the microcontroller may be configured to operate from the power of the signal received at the antenna. Preferably, the microcontroller causes one or more associated objects to be disabled when power from the signal received at the antenna drops below a predetermined level, and in another embodiment to activate one or more objects associated with the microcontroller when the power of the signal received at the antenna is at or above a predetermined level. In accordance with another aspect of the method, the microcontroller receives input signals from one or more associated sensors and generates responsive output control signals to one or more associated objects. Alternatively, the microcontroller receives control signals via the receiver circuit that are generated by the interrogator, which initiate generation of output control signals to the one or more associated objects.

As will be readily appreciated from the foregoing, a low-power microcontroller can be remotely controlled via a two-way radio frequency link to assess conditions and generate control signals. Inputs may include both analog and digital signals that can be used for such things as monitoring temperatures, voltages, and switch status information. Output control signals can be used to control switches, change voltages, control currents, etc. The advantages of a radio frequency tag having these capabilities are many, including rendering items such as night vision goggles useless should they be removed from a warehouse without authorization, tamper detection tags that indicate when an item has been tampered with, and temperature monitoring tags that indicate when an item has gone above or below a preset temperature limit.

### BRIEF DESCRIPTION OF THE SEVERAL VIEWS OF THE DRAWING(S)

The foregoing advantages and features of the present invention will be more readily appreciated as the same become better understood from the following detailed description when taken in conjunction with the accompanying drawings, wherein:

FIG. 1 is a block diagram of a typical radio frequency identification system;

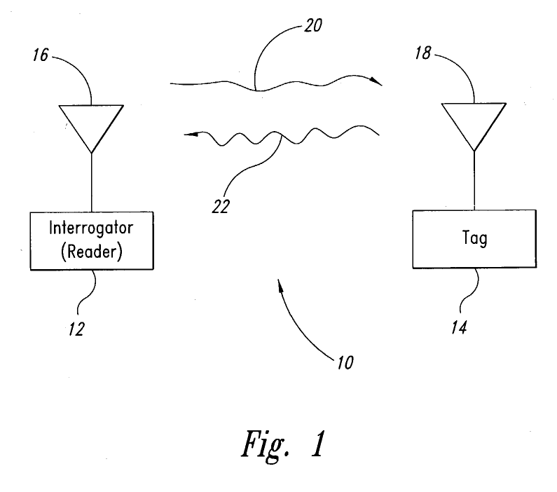

FIG. 2 is a circuit diagram of a first embodiment of the invention;

FIG. 3 is a circuit diagram of a second embodiment of the invention; and

FIG. 4 is a block diagram representation of a system formed in accordance with the present invention.

### DETAILED DESCRIPTION OF THE INVENTION

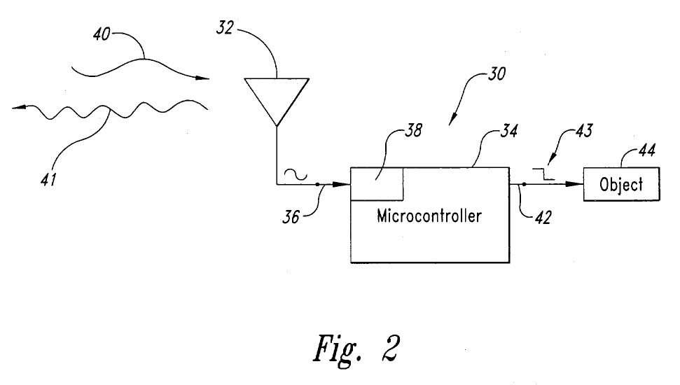

Referring initially to FIG. 2 shown therein is a radio frequency identification tag 30 that includes an antenna 32 coupled to a microcontroller 34 via an input pin 36. Associated with the microcontroller 34 is a passive receiver circuit 38 configured to receive an input signal from the antenna 32, such as an interrogation signal 40. The receiver circuit 38 is of conventional construction and will not be described in detail herein. Briefly, the receiver circuit 38 is configured to operate on the power of the received interrogation signal 40 without the use of stored power, such as from a battery. It is configured to enable backscatter reflection 41 of the interrogation signal 40, thus establishing a two-way RF link with an interrogator (not shown). Similarly, the microcontroller 34 may be constructed using low-power CMOS microcontroller technology or similar technology and operate from the power obtained from the RF signal 40 through the receiver circuit 38. Alternatively, the microcontroller may be powered by stored electrical energy, such as from a battery.

The microcontroller 34 is structured to generate an output signal on. an output control pin 42 to an associated object 44. The object 44 in this particular embodiment is directly coupled electrically to the microcontroller 34.

For example, when the antenna 32 is within range of the radio frequency interrogation signal 40, the microcontroller 34 is awakened by the signal 40. It generates either a responsive signal back to the receiver circuit 38 or an output control signal to the object 44. The output control signal can be preprogrammed into the microcontroller 34 using conventional techniques and circuitry. The control signal 43 may be generated either in response to the interrogation signal or in response to a detected condition, such as temperature, switch positions, and the like. In addition, when the microcontroller is out of range of the radio frequency signal 40, it can be configured to not generate a control signal. This condition can be used to disable or turn off the object 44, which is particularly useful in applications where the object 44 is removed, such as from a warehouse, without authorization. Such objects can include weapons, keys, tools, and the like. The output control signal 43 can also be used to enable the object 44 or otherwise control its operation.

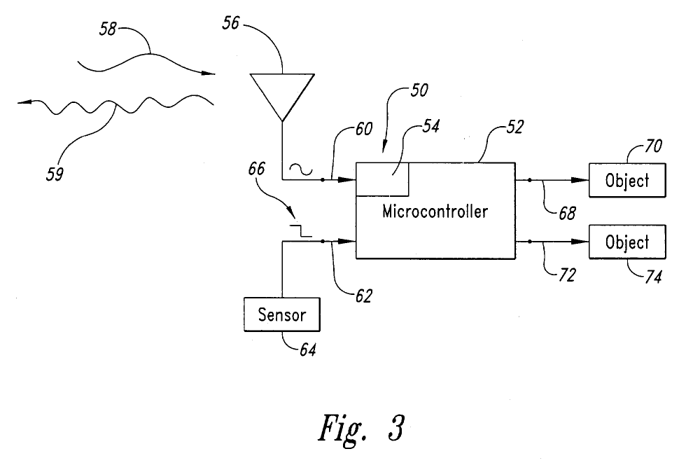

Turning next to FIG. 3, shown therein is a radio frequency tag device 50 having a microcontroller 52 associated with a receiver circuit 54 that is coupled to an antenna 56. As with the embodiment depicted in FIG. 2, the antenna 56 is configured to receive a radio frequency signal 58 and to reflect a backscattered signal 59. Preferably, the energy of the RF signal 58 is used to power the receiver circuit 54, and it can be used to power the microcontroller 52 without the use of stored power or an external power source. However, stored energy or an external power source can be used if desired. The signal 58 received at the antenna 56 is transmitted to an input pin 60 coupled to the receiver circuit 54. A second input pin 62 is coupled to a sensor 64 that generates a digital input signal 66. The sensor 64 represents any device or method of monitoring a condition, such as an environmental factor or a condition or state of an object, including, but not limited to switch settings, location, temperature, light, sound, ambient energy, and the like. The microcontroller 52 is configured to generate an output control signal responsive to the input signal 66 from the sensor 64. The output control signal may either be a responsive signal to the interrogator or it may be a control signal that is generated on a first output control pin 68 to a first object 70. The microcontroller 52 can also be configured to generate a second output control signal on a second output control pin 72 to be received by a second object 74.

In this embodiment, the microcontroller 52 is configured to control the operation of the first object 70 or the first and second objects 70, 74 in response to input signals 66 from the sensor 64, with the microcontroller 52 powered by the reception of the radio frequency beam 58. It is to be understood that input signals can be utilized from multiple sensors, if called for by the application. One example of a practical application would be monitoring the temperature of a refrigeration unit via the sensor 64,. and using the output control pins 68, 72 to control the operation of the refrigeration unit and to control an alarm, indicator light, temperature gauge, or other visual, tactile, or auditory device.

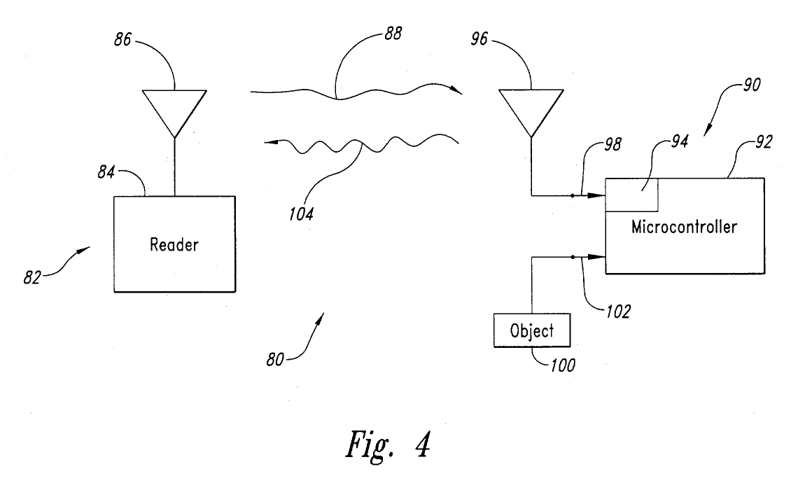

FIG. 4 represents a system 80 formed in accordance with another embodiment of the invention wherein an interrogation unit 82 comprising a reader 84 and an antenna 86 are used to generate an interrogation signal 88. The system 80 further includes at least one radio frequency tag 90 having a microcontroller 92 and an associated receiver circuit 94 coupled to an antenna 96 via a first input pin 98. The tag 90 is coupled to an object 100 via a second input pin 102. The condition of the object 100 is monitored by the microcontroller 92, which condition is then sent via the antenna 96 to the interrogation unit 82 as a backscatter signal 104.

As with the other embodiments, while the receiver circuit 94 and the microcontroller 92 are powered by the energy derived from the radio frequency interrogation signal 88 they may be powered by stored energy or by an outside energy source. In either case, when the signal 88 is received, the microcontroller 92 powers up and determines the condition of the object 100 upon which the modulated reflected signal 104 is sent back to the reader antenna 86. This configuration is useful in determining the condition of the object 100, such as whether the object 100 has been tampered with.

In accordance with the method of the invention, new low-power CMOS microcontrollers and other similar controllers make it feasible to construct a radio frequency tag that will obtain sufficient power from the RF beam to activate the microcontroller. Such microcontrollers are readily commercially available and will not be described in detail herein. The microcontrollers have both input and output control pins, and inputs may include reception of both analog and digital signals that can be used for such things as monitoring temperatures, voltages, and switch status information. In accordance with another step of the invention, the microcontroller powered by the RF beam generates output control signals used for controlling switches, changing voltages, and altering currents, and the like.

While representative embodiments of the invention have been illustrated and described, it is to be understood that various changes may be made therein without departing from the scope of the invention. Thus, the invention is to be limited only by the accompanying claims and the equivalents thereof.

1. A radio frequency device, comprising:
an antenna configured to receive and send radio frequency signals;
a receiver circuit coupled to the antenna and configured to operate from the power of the received radio frequency signals; and
a microcontroller having at least one input coupled to the receiver circuit and at least one output control pin, the microcontroller configured to operate on the power of the radio frequency signal received at the receiver circuit and to generate output control signals in response to a condition.

2. The device of claim 1 wherein the condition comprises control signals in the radio frequency signal received at the receiver circuit.

3. The device of claim 1 wherein the condition comprises a condition of an object associated with the microcontroller.

4. The device of claim 1 wherein the condition comprises reception of input signals from one or more sensors.

5. A system for input and output control, comprising:
an antenna configured to receive and send radio frequency signals;
a receiver circuit coupled to the antenna and configured to operate from the power of the radio frequency signal received at the antenna for two-way radio frequency communication; and
a microcontroller having at least one input pin coupled to the receiver circuit and at least one output control pin, the microcontroller configured to generate at least one signal in response to a received radio frequency signal, the at least one signal comprising one of either a control signal and a response signal, the response signal comprising data regarding a monitored condition of an object electronically coupled to the microcontroller, the object configured to be responsive to the control signal from the microcontroller.

6. The system of claim 5 further comprising an sensor coupled to the object and to the microcontroller and configured to detect a condition of the object and to send at least one condition signal to the microcontroller responsive to the detected condition of the object.

7. The system of claim 5 wherein the microcontroller is configured to disable the object when the microcontroller no longer receives sufficient power from the radio frequency signal to operate.

8. The system of claim 5 wherein the receiver circuit and the microcontroller are configured to operate from the power of the received radio frequency signal.

9. A system for remote tracking and controlling, comprising:
an object;
an interrogation device configured to send and receive the radio frequency signals; and
a radio frequency device coupled to the object comprising an antenna configured to receive a radio frequency signal, a receiver circuit coupled to the antenna and configured to operate from the power of radio frequency signal to establish a two-way radio frequency communication link, and a microcontroller having a plurality of input pins and at least one output control pin, the microcontroller configured to receive at least one input signal on at least one input pin from at least one associated sensor and to generate at least one output control signal to the object on at least one output control pin responsive to the input signals.

10. The system of claim 9 wherein the microcontroller is configured to receive at least one digital signal from the at least one sensor.

11. The system of claim 9 wherein the microcontroller is configured to respond to control signals received on the antenna and to generate output control signals to the object responsive thereto for controlling the operation of the object.

12. The system of claim 9 wherein the receiver circuit is configured to modulate the radio frequency signal and reflect the same via the antenna to the interrogator.

13. The system of claim 9 wherein the microcontroller is configured to operate on the power from the received radio signal.
